(19) United States
(12) Patent Application Publication
(10) Pub. No.: US 2018/0290057 A1
(43) Pub. Date: Oct. 11, 2018

(54) DYNAMIC SCALING OF AUGMENTED REALITY-BASED GAME

(71) Applicant: Brian Mullins, Altadena, CA (US)

(72) Inventor: Brian Mullins, Altadena, CA (US)

(21) Appl. No.: 15/483,484

(22) Filed: Apr. 10, 2017

(51) Int. Cl. A63F 13/5378; G06T 3/40; G06T 11/60; A63F 13/79; A63F 13/335

(52) U.S. Cl. CPC A63F 13/5378; G06T 3/40; A63F 13/335; A63F 13/79; G06T 11/60

(57) ABSTRACT

An Augmented Reality (AR)-based gaming application identifies a plurality of AR markers. Each AR marker identifies a corresponding geolocation and corresponding AR content. A gaming geographic area is formed based on a profile of a user of the AR-based gaming application. The geolocations of the plurality of AR markers are mapped to the gaming geographic area. A playspace of the user of the AR-based gaming application is dynamically scaled to the gaming geographic area.

### TECHNICAL FIELD

The subject matter disclosed herein generally relates to an augmented-reality gaming application. Specifically, the present disclosure addresses systems and methods for dynamically scaling a geographic play space of an augmented reality-based game.

### BACKGROUND

An augmented reality (AR) device can be used to generate and display data in addition to an image captured with the AR device. For example, AR is a live, direct, or indirect view of a physical, real-world environment whose elements are augmented by computer-generated sensory input such as sound, video, graphics or Global Positioning System (GPS) data. With the help of advanced AR technology (e.g., adding computer vision and object recognition), the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network environment suitable for operating an augmented reality-based gaming system, according to some example embodiments.

FIG. 2 is a block diagram illustrating an example of a user looking through a transparent display of an augmented reality device to view an augmented reality experience as an overlay on a physical object.

FIG. 3 is a block diagram illustrating an example embodiment of an augmented reality device.

FIG. 4 is a block diagram illustrating an example embodiment of a server.

FIG. 5 is a block diagram illustrating an example embodiment of a dynamic playspace scaling application.

FIG. 6A is a diagram illustrating an example of an augmented reality-based game playspace.

FIG. 6B is a diagram illustrating an example of augmented reality-based game playspaces based on game levels.

FIG. 6C is a diagram illustrating an example of an augmented reality-based game playspace based on user frequent locations.

FIG. 6D is a diagram illustrating another example of an augmented reality-based game playspace based on user frequent locations.

FIG. 6E is a diagram illustrating an example of augmented reality-based game playspaces based on a user base location.

FIG. 7 is a flowchart illustrating a method for dynamically adjusting a playspace of an augmented reality-based game, according to one example embodiment.

FIG. 8 is a flowchart illustrating a method for dynamically adjusting a playspace of an augmented reality-based game, according to another example embodiment.

FIG. 9 is a flowchart illustrating a method for dynamically adjusting a playspace of an augmented reality-based game, according to yet another example embodiment.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to dynamic scaling of a geographic playspace of an AR-based gaming application. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, a user plays an AR-based game through a mobile device, such as a mobile computing device (e.g., smart phone, tablet). An AR-based gaming application operates on the mobile device and provides an AR experience that includes overlaying virtual content (e.g., computer-generated 3D models, images, or video) over optically captured images of real-world objects at a geographic location of the mobile device. The virtual content may be displayed in a transparent or non-transparent display of the mobile device. The AR-based gaming application operates a game in which the user completes levels by capturing real or virtual objects at predefined geographic locations. For example, the user is directed to a specific geographic location (e.g., a local playground) to seek a specific physical object (e.g., a slide) and optically capture an image of the specific physical object at the specific geographic location in order to trigger an AR experience corresponding to a completion of a task or level of the AR-based gaming application. The AR experience may include, for example, generating and displaying a virtual character (e.g., cartoon animal) sliding down the slide. To successfully complete the AR-based game, the user is required to visit different specific geographic locations and perform predefined operations (e.g., tapping on the cartoon animal while the cartoon animal slides down the slide, or tapping on virtual obstacles that prevent the cartoon animal from sliding down the slide).

Different specific geographic locations and/or specific physical objects may be associated with different levels of the AR-based game operated by the AR-based gaming application. An AR marker defines a specific geographic location and/or specific physical object in order to trigger a corresponding AR experience at the specific geographic location. Each level of the AR-based gaming application may include a set of AR markers at different geographic locations. The playspace of the AR-based gaming application includes the geographic area covered by the AR markers from one or more levels (or all levels) of the AR-based gaming application.

For example, an easy level of the AR-based gaming application includes a first set of AR markers located at various geographic locations spread within a mile of a predefined base geographic location of the user (e.g., a workplace of the user). The playspace of the easy level of the AR-based gaming application includes a geographic area defined by the first set of AR markers.

In another example, an intermediate level of the AR-based gaming application includes a second set of AR markers located further away from the predefined base geographic location of the user. As such, the user would have to travel further away from his workplace to complete the intermediate level of the AR-based gaming application. The playspace of the intermediate level of the AR-based gaming application includes a geographic area defined by the second set of AR markers.

The playspace of the AR-based gaming application can be dynamically scaled based on a profile of the user of the AR-based gaming application. Examples of entries in the profile of the user include a home/work address, frequently visited locations (e.g., church, gym, restaurants), frequent routes (e.g., freeway and streets from home to work), places visited on previous vacations, a favorite type of food (e.g., pizza), preferred or saved vacation places (e.g., Hawaii), social network data, and so forth.

In one example embodiment, the playspace of every level of the AR-based gaming application includes a geographic area formed within 10 miles of the home address of the user of the AR-based gaming application. Therefore, the user of the AR-based gaming application can play and complete the entire game without having to travel beyond 10 miles of his/her home address.

In another example embodiment, the playspace of a higher level of the AR-based gaming application includes a geographic area based on a preferred vacation place (or a place not previously visited by the user). For instance, the user may have to travel to Hawaii to complete the higher level of the AR-based gaming application.

In another example embodiment, the playspace of the AR-based gaming application includes a geographic area formed along a workweek travel route of the user. For example, AR markers are placed at different places (e.g., coffee shops, restaurants, grocery stores) along the workweek travel route of the user. Therefore, the user could play and complete the AR-based gaming application without having to deviate from his/her routine travel path.

In one example embodiment, a server executes the AR-based gaming application in one or more hardware processors of the server. The AR-based gaming application determines or identifies a plurality of AR markers from the AR-based gaming application. For example, the AR-based gaming application defines each AR marker with identifying a corresponding geolocation and corresponding AR content. A gaming geographic area is formed based on a profile of a user of the AR-based gaming application. The geolocations of the plurality of AR markers are mapped to the gaming geographic area. The playspace of the user of the AR-based gaming application is dynamically scaled to the gaming geographic area.

In another example embodiment, the AR-based gaming application forms a first geographic area, and a second geographic area around the first geographic area. Both the first and second geographic areas are within the gaming geographic area. A first set of AR markers is mapped to a first level of the AR-based gaming application in the first geographic area. A second set of AR markers is mapped to a second level of the AR-based gaming application in the second geographic area. The plurality of AR markers includes the first and second sets of AR markers. The AR-based gaming application forms a first-level playspace of the user inside the first geographic area. The AR-based gaming application forms a second-level playspace of the user inside the second geographic area. The second level of the AR-based gaming application has a higher gaming difficulty than does the first level of the AR-based gaming application.

In another example embodiment, the AR-based gaming application identifies a home geographic location from the profile of the user. The gaming geographic area is formed around the home geographic location.

In another example embodiment, the AR-based gaming application identifies a home geographic location from the profile of the user. A first geographic area is formed around the home geographic location. A second geographic area is formed around the first geographic area. A first set of AR markers is mapped to a first level of the AR-based gaming application in the first geographic area. A second set of AR markers is mapped to a second level of the AR-based gaming application in the second geographic area. The plurality of AR markers includes the first and second sets of AR markers. A first-level playspace of the user is formed inside the first geographic area. A second-level playspace of the user is formed inside the second geographic area.

In another example embodiment, the AR-based gaming application identifies user frequent geographic locations from the profile of the user. The gaming geographic area is formed around and includes the user frequent geographic locations.

In another example embodiment, the AR-based gaming application identifies a first geographic location of the user from the profile of the user and a second geographic location of the user from the profile of the user. The gaming geographic area is formed around and includes the first and second geographic locations. The plurality of AR markers is mapped to the gaming geographic area between the first and second geographic locations of the user.

In another example embodiment, the plurality of AR markers is identified in all game levels of the AR-based gaming application. All game levels of the AR-based gaming application are played in the playspace of the user of the AR-based gaming application.

In another example embodiment, the AR-based gaming application receives a geolocation of an AR device of the user, retrieves an AR marker of the plurality of AR markers corresponding to the geolocation of the AR device, and provides the AR content corresponding to the retrieved AR marker to the AR device. The AR device displays the AR content at the geolocation of the AR device.

In another example embodiment, the AR device receives sensor data from sensors in the AR device. The AR device displays the AR content in response to the sensor data being with predefined parameters.

In another example embodiment, the AR-based gaming application forms a first geographic area based on a home location of the user, and a second geographic area based on activities of the user on a social network application. A first set of AR markers of the plurality of AR markers is mapped to a first level of the AR-based gaming application in the first geographic area. A second set of AR markers of the plurality of AR markers is mapped to a second level of the AR-based gaming application in the second geographic area. A first-level playspace of the user is formed inside the first geographic area. A second-level playspace of the user is formed inside the second geographic area.

In another example embodiment, a non-transitory machine-readable storage device may store a set of instructions that, when executed by at least one processor, causes the at least one processor to perform the method operations discussed within the present disclosure.

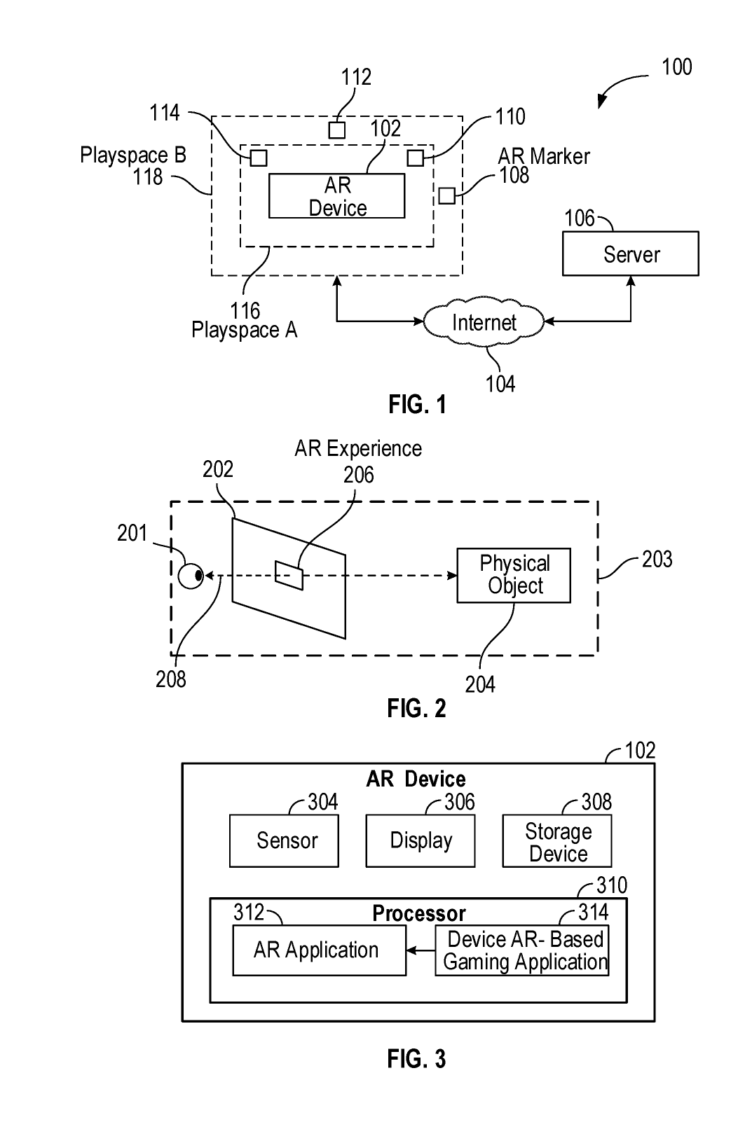

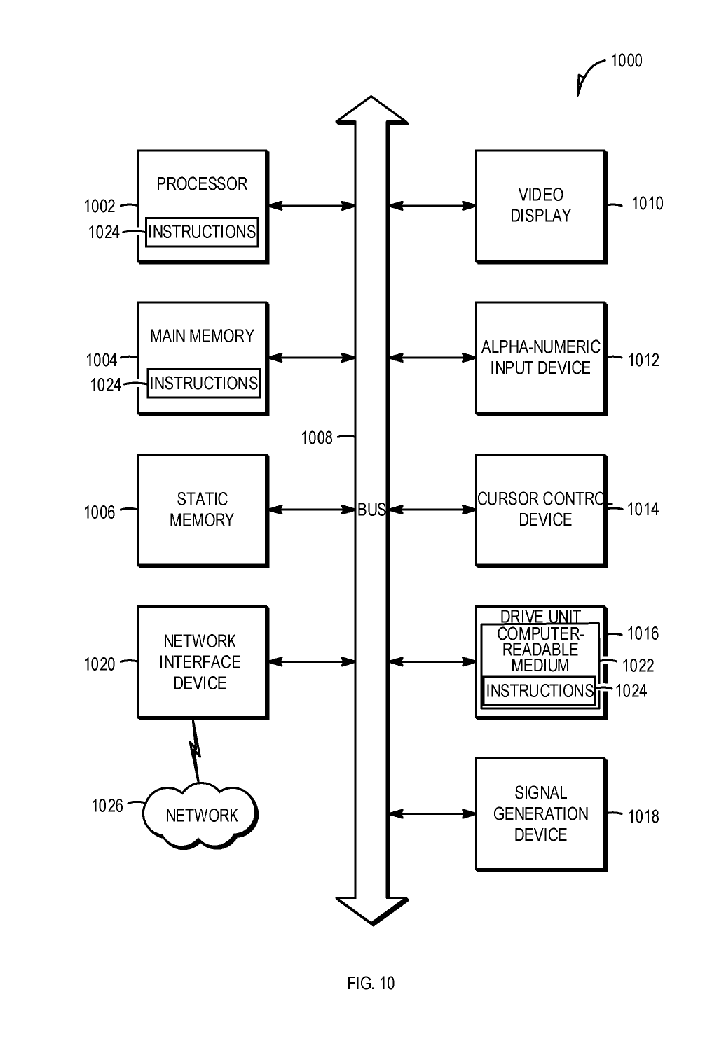

FIG. 1 is a network diagram illustrating a network environment 100 suitable for operating an AR-based gaming application, according to some example embodiments. The network environment 100 includes an AR device 102 and a server 106, communicatively coupled to each other via a network 104 (e.g., the Internet). Both the AR device 102 and the server 106 execute an AR-based gaming application. The AR device 102 and the server 106 may each be implemented in a computer system, in whole or in part, as described below with respect to FIG. 10.

The server 106 may be part of a network-based system. For example, the network-based system may be or include a cloud-based server system that provides AR content (e.g., AR markers; AR experience including 3D models of virtual objects, animations, images, video) to the AR device 102.

The AR device 102 may include a wearable computing device (e.g., smart glasses, smart visor, smart eyewear, smart helmet, smart phone) that a user can wear to see or experience the AR content related to captured images of predefined physical objects at a specific geographic location in a real-world physical environment. FIG. 2 illustrates an example embodiment of a user 201 looking through (via line of sight 208) a transparent display 202 of the AR device 102 to view an AR experience 206 (e.g., virtual content) as an overlay on a physical object 204. The AR experience 206 is triggered and displayed in the display 202 when an optical device (e.g., a camera) of the AR device 102 captures an image of the physical object 204 and detects the physical object 204 at a geographic location 203.

In another example, the display 202 of the AR device 102 includes a non-transparent display.

The user 201 may be a user of an AR-based gaming application executed in the AR device 102 and at the server 106. The user 201 may be a human user (e.g., a human being), a machine user (e.g., a computer configured by a software program to interact with the AR device 102), or any suitable combination thereof (e.g., a human assisted by a machine or a machine supervised by a human). The user 201 is not part of the network environment 100, but is associated with the AR device 102.

Referring back to FIG. 1, the server 106 forms and defines a playspace (of the AR-based gaming application) that is specifically tailored to the user 201 of the AR-based gaming application. For example, the server 106 defines playspace A 116 for an easy level of the AR-based gaming application and playspace B 118 for a hard level of the AR-based gaming application. The AR-based gaming application places AR markers 110, 114 (both corresponding to the easy level) inside playspace A 116. The AR-based gaming application places AR markers 108, 112 (corresponding to the hard level) outside playspace A 116 and inside playspace B 118.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The network 104 may be any network that enables communication between or among machines (e.g., server 106), databases, and devices (e.g., AR device 102). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof

FIG. 3 is a block diagram illustrating modules (e.g., components) of the AR device 102, according to some example embodiments. The AR device 102 may be a wearable device that includes sensors 304, a display 306, a storage device 308, and a processor 310. The AR device 102 may include any type of device that can be worn on the head of a user (e.g., user 201) such as a headband, a hat, or a visor.

The sensors 304 may be used to generate internal tracking data (e.g., using gyroscope data, accelerometer data, or inertial motion unit data) of the AR device 102 to determine a position and an orientation of the AR device 102. The position and the orientation of the AR device 102 may be used to identify real-world objects in a field of view of the AR device 102. For example, a virtual object may be rendered and displayed in the display 306 when the sensors 304 indicate that the AR device 102 is oriented towards a real-world object (e.g., when the user 201 looks at the physical object 204 using the AR device 102) or in a particular direction (e.g., when the user 201 tilts his or her head to look up to the sky at the geographic location 203). The AR device 102 may also display a virtual object based on a current geographic location of the AR device 102. For example, a set of virtual objects may be accessible when the user 201 is located in a particular location (e.g., at a park). Different levels of content of the virtual objects may be accessible based on a profile of the user. For example, a user who is an avid gamer may have access to more information or content in the virtual objects than a novice gamer present at the same particular location.

Examples of sensors 304 include a camera, an audio sensor, an Inertial Motion Unit (IMU) sensor, a geographic location sensor, a barometer, a humidity sensor, an ambient light sensor, and a biometric sensor. It is to be noted that the sensors 304 described herein are for illustration purposes. The sensors 304 are thus not limited to the ones described.

The display 306 includes a display surface or lens capable of displaying AR content (e.g., images, video) generated by the processor 310. The display 306 may be transparent so that the user 201 can see through the display 306 (e.g., such as a head-up display).

The storage device 308 stores a library of AR markers, AR content/experiences, a profile of the user 201, and customized playspaces for the user 201. The AR content/experiences may include two- or three-dimensional models of virtual objects with corresponding audio.

The storage device 308 may also store a database that identifies reference objects (visual references or images of objects) and corresponding AR experiences (e.g., animations, 3D virtual objects, interactive features of the 3D virtual objects).

In one example embodiment, the AR device 102 communicates over the network 104 with the server 106 to access a database of the AR markers and playspaces from the server 106. In another example embodiment, the AR device 102 retrieves AR markers (and corresponding playspaces) corresponding to a first level of the game from the server 106. Once the AR device 102 detects that the user 201 has completed the first level of the game, the AR device 102 retrieves AR markers (and corresponding playspaces) corresponding to a second level of the game from the server 106.

The processor 310 includes an AR application 312 and a device AR-based gaming application 314. The AR application 312 generates a display of virtual content when the AR device 102 detects the physical object 204 at the geographic location 203. In one example embodiment, the AR application 312 generates virtual content overlaid on an image or a view of the physical object 204 when the AR device 102 captures an image of the physical object 204, recognizes the physical object 204, and determines that the AR device 102 is located at the geographic location 203.

The device AR-based gaming application 314 includes a gaming application where different levels can be completed by interacting with AR content that is triggered and displayed in the display 306 when the AR device 102 is located at a specific AR marker of the AR-based gaming application 314. In particular, the device AR-based gaming application 314 defines a dynamic playspace based on a profile of the user 201. For example, the playspace can be made smaller for easier levels or to make it easier for the user 201 to complete the game.

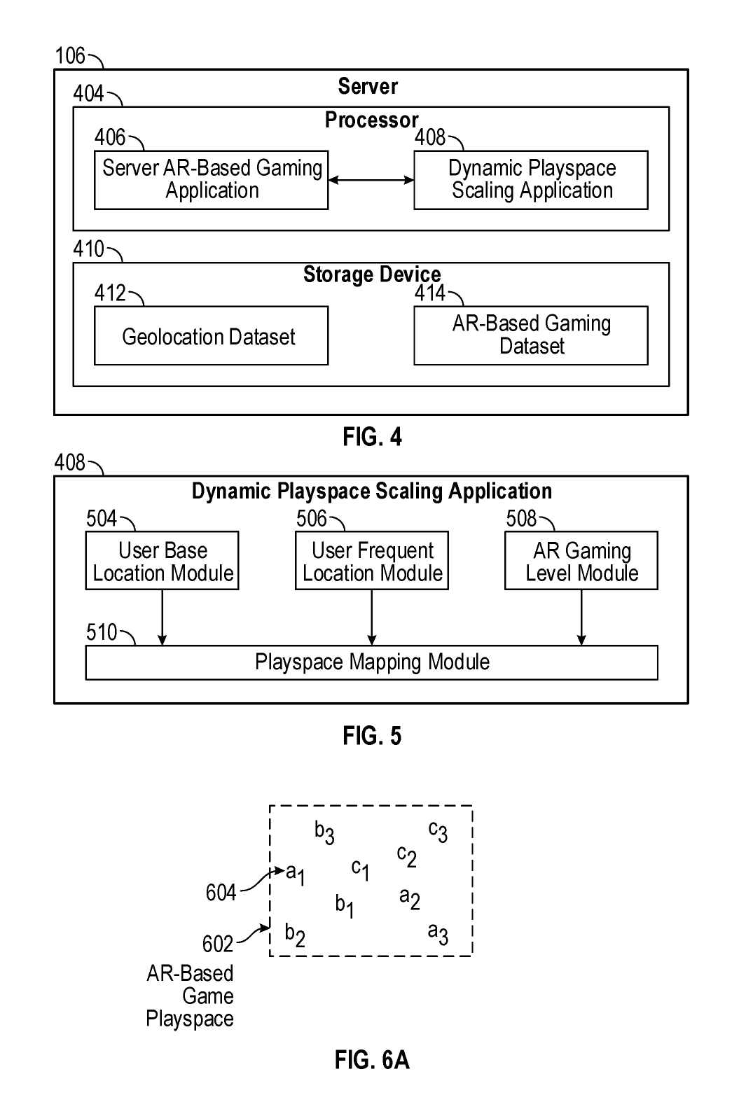

FIG. 4 is a block diagram illustrating modules (e.g., components) of the server 106. The server 106 includes a processor 404, and a storage device 410. The processor 404 includes a server AR-based gaming application 406 and a dynamic playspace scaling application 408. The server AR-based gaming application 406 includes instructions to operate an AR game for the AR device 102. For example, the server AR-based gaming application 406 generates a playspace customized for the user 201 and communicates the customized playspace to the device AR-based gaming application 314 of the AR device 102.

The dynamic playspace scaling application 408 generates a playspace for the game operated by the server AR-based gaming application 406. In one example embodiment, the dynamic playspace scaling application 408 scales a playspace of the game based on the profile of the user 201. Example components of the dynamic playspace scaling application 408 are described in more detail below with respect to FIG. 5.

The storage device 410 stores a geolocation dataset 412 and an AR-based gaming dataset 414. The geolocation dataset 412 includes AR marker data for each level or all levels of the game. For example, the AR marker data identifies a playspace, a level, a geographic location, a physical object, an AR experience, and a user interaction with respect to the AR experience/physical object.

The AR-based gaming dataset 414 includes gaming data related to the server AR-based gaming application 406. For example, the gaming data includes gaming levels, gaming operations (e.g., how the game works), and gaming instructions (e.g., executable code of the game).

FIG. 5 is a block diagram illustrating an example embodiment of the dynamic playspace scaling application 408. The dynamic playspace scaling application 408 is shown by way of example to include a user base location module 504, a user frequent location module 506, an AR gaming level module 508, and a playspace mapping module 510. The user base location module 504 identifies a base location for the user 201. The base location includes, for example, a home or work address of the user 201 or any other location preset by the user 201. The user frequent location module 506 identifies frequent locations visited by the user 201. The user frequent locations include, for example, a restaurant location, a gym location, or a friend address. In another example, the user frequent location module 506 identifies a frequent route used by the user (e.g., driving route from home to work). The AR gaming level module 508 identifies different levels of the game of the server AR-based gaming application 406.

The playspace mapping module 510 dynamically forms and defines a playspace based on a combination of data from the user base location module 504, the user frequent location module 506, and the AR gaming level module 508. For example, the playspace mapping module 510 obtains data from the user base location module 504 and forms a playspace based on where the user lives (e.g., a geographic area that includes the city where the user lives). Therefore, the user can complete the game by visiting locations within the city. In another example embodiment, the playspace mapping module 510 forms a playspace for each level of the game. For example, a first playspace corresponds to a first level of the game and a second playspace corresponds to a second level of the game. As such, level one of the game may be completed within the home town of the user, while level two of the game may be completed by visiting a neighboring town of the user.

In another example embodiment, the playspace mapping module 510 obtains data from the user frequent location module 506 and forms a playspace based on where the user frequently travels to. Therefore, the user can complete the game by visiting those locations. In another example embodiment, level one of the game may be completed by visiting locations along a first route (e.g., home to work), while level two of the game may be completed by visiting locations along a second route (e.g., work to gym).

Any one or more of the modules described herein may be implemented using hardware (e.g., processors 310 or 404 of a machine) or a combination of hardware and software. For example, any module described herein may configure the processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

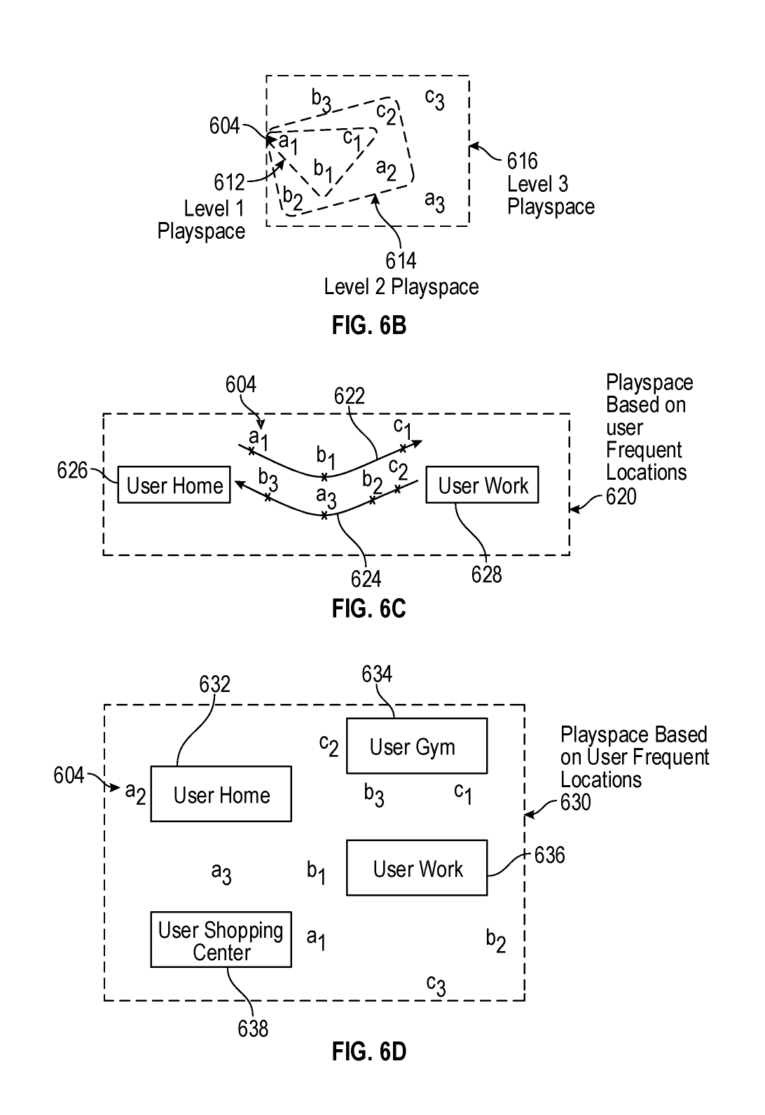

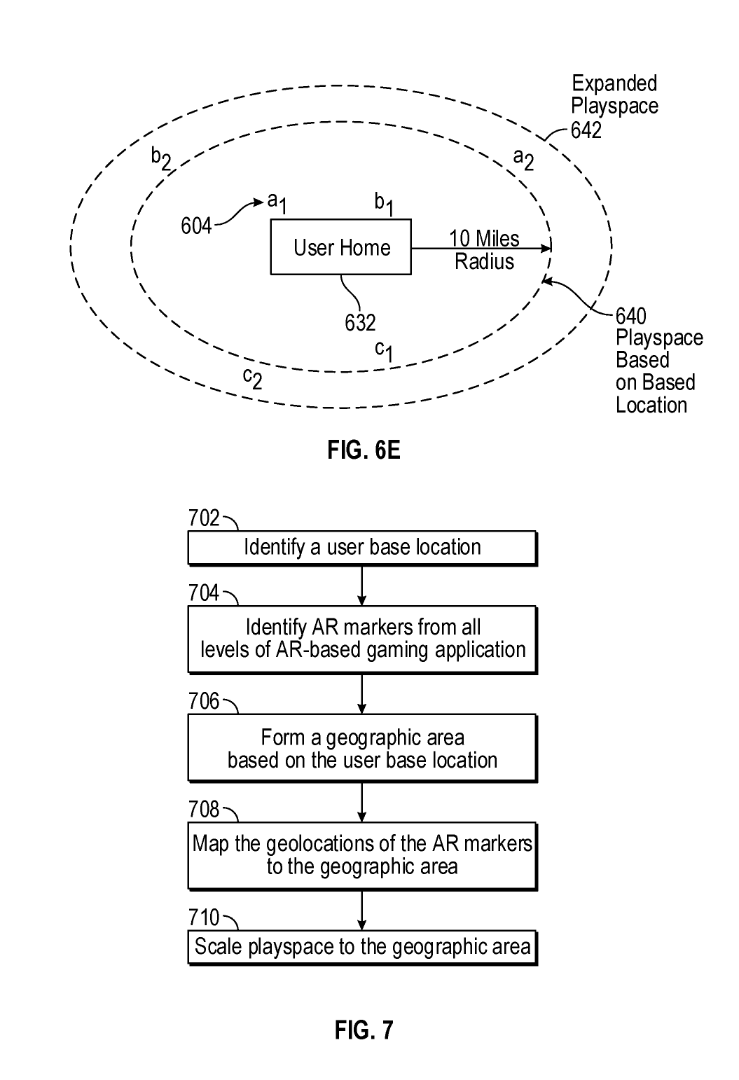

FIG. 6A is a diagram illustrating an example of an augmented reality-based game playspace 602. The playspace mapping module 510 places AR markers 604 within the AR-based game playspace 602. Therefore, the entire game can be completed by visiting the AR markers 604 within the AR-based game playspace 602.

FIG. 6B is a diagram illustrating an example of augmented reality-based game playspaces based on game levels. The playspace mapping module 510 places AR markers 604 within different playspaces according to a game level of the AR game. AR markers a1, b1, c1 604 are placed inside a playspace 612 corresponding to a first level of the game. AR markers a2, b2, c2 604 are placed outside the playspace 612 and inside a playspace 614, and correspond to a second level of the game. AR markers a3, b3, c3 604 are placed outside the playspace 614 and inside a playspace 616, and correspond to a third level of the game. Therefore, a user would have to visit AR markers 604 within the playspace 612 to complete the first level of the AR game. The user would then have to travel outside the playspace 612 and inside the playspace 614 to complete the second level of the AR game. Similarly, the user travels outside the playspace 614 and inside the playspace 616 to complete the third level of the AR game.

FIG. 6C is a diagram illustrating an example of an augmented reality-based game playspace 620 based on user frequent locations. The playspace 620 is based on routes between the user frequent locations. For example, a first route 622 and a second route 624 are defined between a user home 626 and a user work 628. AR markers a1, b1, c1 604 are placed along the first route 622. AR markers b3, a3, b2, c2 604 are placed along the second route 624. Therefore, a user would have to visit AR markers a1, b1, c1 604 along the first route 622 to complete the first level of the AR game. Similarly, a user would have to visit AR markers b3, a3, b2, c2 604 along the second route 624 to complete the second level of the AR game.

FIG. 6D is a diagram illustrating another example of an augmented reality-based game playspace 630 based on user frequent locations. The playspace 630 is based on the user frequent locations. For example, frequent locations of the user include a user home 632, a user gym 634, a user work 636, and a user shopping center 638. AR markers 604 are thus placed within the vicinity of those frequent locations and within the playspace 630. Therefore, the entire game can be completed by visiting the AR markers 604 within the AR-based game playspace 630.

FIG. 6E is a diagram illustrating an example of augmented reality-based game playspaces based on a user base location. A playspace 640 of a first level of the AR game includes a geographic area within a predefined radius of the user home 632. AR markers a1, b1, c1 604 are positioned within the playspace 640. A playspace 642 of a second level of the AR game includes a geographic area outside the playspace 640. AR markers a2, b2, c2 604 are positioned within the playspace 642.

FIG. 7 is a flowchart illustrating a method for dynamically adjusting a playspace of an augmented reality-based game, according to one example embodiment. At operation 702, the playspace mapping module 510 identifies a user base location. At operation 704, the playspace mapping module 510 identifies AR markers from all levels of the AR-based gaming application. At operation 706, the playspace mapping module 510 forms a geographic area based on the user base location. At operation 708, the playspace mapping module 510 maps the geolocations of the AR markers to the geographic area. At operation 710, the playspace mapping module 510 scales the playspace to the geographic area.

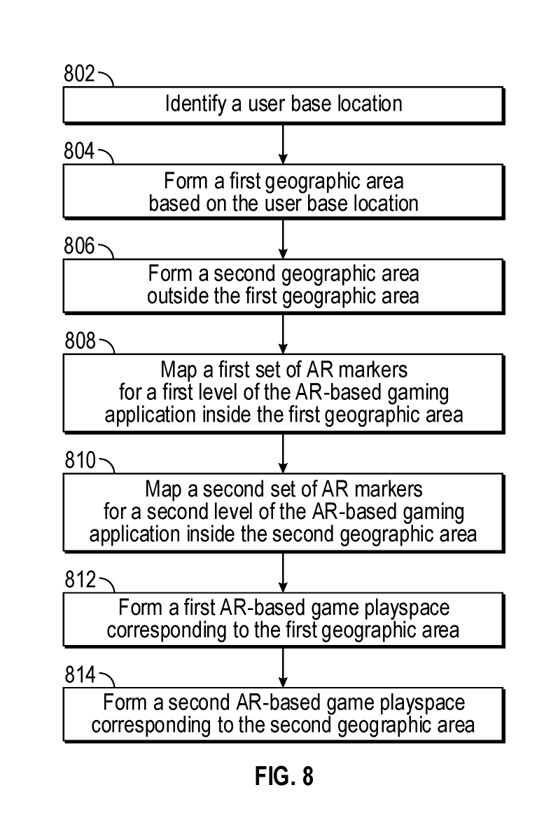

FIG. 8 is a flowchart illustrating a method for dynamically adjusting a playspace of an augmented reality-based game, according to another example embodiment. At operation 802, the playspace mapping module 510 identifies a user base location. At operation 804, the playspace mapping module 510 forms a first geographic area based on the user base location. At operation 806, the playspace mapping module 510 forms a second geographic area outside the first geographic area. At operation 808, the playspace mapping module 510 maps a first set of AR markers for a first level of the AR-based gaming application inside the first geographic area. At operation 810, the playspace mapping module 510 maps a second set of AR markers for a second level of the AR-based gaming application inside the second geographic area. At operation 812, the playspace mapping module 510 forms a first AR-based game playspace corresponding to the first geographic area. At operation 814, the playspace mapping module 510 forms a second AR-based game playspace corresponding to the second geographic area.

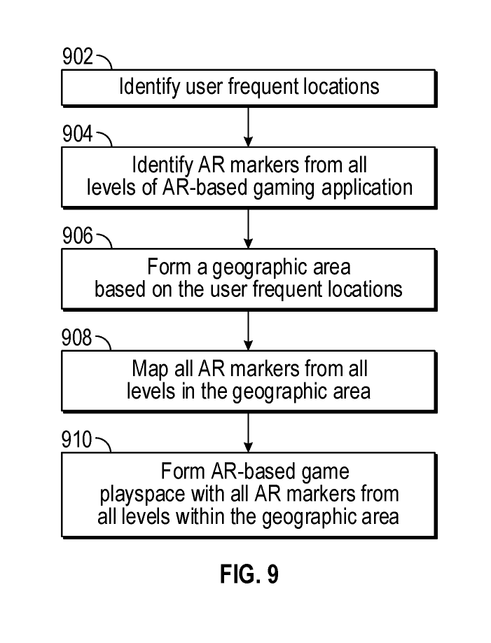

FIG. 9 is a flowchart illustrating a method for dynamically adjusting a playspace of an augmented reality-based game, according to yet another example embodiment. At operation 902, the playspace mapping module 510 identifies user frequent locations. At operation 904, the playspace mapping module 510 identifies AR markers from all levels of the AR-based gaming application. At operation 906, the playspace mapping module 510 forms a geographic area based on the user frequent locations. At operation 908, the playspace mapping module 510 maps all AR markers from all levels in the geographic area. At operation 910, the playspace mapping module 510 forms an AR-based game playspace with all AR markers from all level within the geographic area.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 404 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 404 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 404 configured using software, the general-purpose processor 404 may be configured as respective different hardware modules at different times. Software may accordingly configure a processor 404, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between or among such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 404 that are temporarily configured (e.g., by software) or permanently configured to perform the relevant operations. Whether temporarily or permanently configured, such processors 404 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 404 or processor-implemented modules. The performance of certain of the operations may be distributed among the one or more processors 404, not only residing within a single machine, but deployed across a number of machines. In some example embodiments, the processor or processors 404 may be located in a single location (e.g., within a home environment, an office environment, or a server farm), while in other embodiments the processors 404 may be distributed across a number of locations.

The one or more processors 404 may also operate to support performance of the relevant operations in a “cloud computing” environment or as a “software as a service” (SaaS). For example, at least some of the operations may be performed by a group of computers (as examples of machines including processors 404), these operations being accessible via a network 104 and via one or more appropriate interfaces (e.g., application programming interfaces (APIs)).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 404, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network 104.

In example embodiments, operations may be performed by one or more programmable processors 404 executing a computer program to perform functions by operating on input data and generating output. Method operations can also be performed by, and apparatus of example embodiments may be implemented as, special-purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 404), or in a combination of permanently and temporarily configured hardware may be a design choice. Below are set out hardware (e.g., machine) and software architectures that may be deployed, in various example embodiments.

### Example Machine Architecture

FIG. 10 is a block diagram of a machine in the example form of a computer system 1000 within which instructions 1024 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 106 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, a network switch, a network bridge, or any machine capable of executing the instructions 1024 (sequential or otherwise) that specify actions to be taken by that machine. Further, while only a single machine is illustrated, the term “machine” shall also be taken to include any collection of machines that individually or jointly execute a set (or multiple sets) of instructions 1024 to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a disk drive unit 1016, a signal generation device 1018 (e.g., a speaker), and a network interface device 1020.

### Machine-Readable Medium

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media 1022. The instructions 1024 may also reside, completely or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers 106) that store the one or more instructions 1024 or data structures. The term “machine-readable medium” shall also be taken to include any tangible medium that is capable of storing, encoding, or carrying the instructions 1024 for execution by the machine and that cause the machine to perform any one or more of the methodologies of the present embodiments, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1024 may further be transmitted or received over a communication network 1026 using a transmission medium. The instructions 1024 may be transmitted using the network interface device 1020 and any one of a number of well-known transfer protocols (e.g., hypertext transfer protocol (HTTP)). Examples of communication networks 1026 include a local-area network (LAN), a wide-area network (WAN), the Internet, mobile telephone networks, plain old telephone service (POTS) networks, and wireless data networks (e.g., WiFi and WiMax networks). The term “transmission medium” shall be taken to include any intangible medium capable of storing, encoding, or carrying the instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following embodiments describe various example embodiments of methods, machine-readable media, and systems (e.g., machines, devices, or other apparatus) discussed herein.

### EXAMPLES

A first example provides a server comprising:
one or more hardware processors comprising an augmented reality (AR)-based gaming application, the AR-based gaming application configured to perform operations comprising:
identifying, by the one or more hardware processors, a plurality of AR markers from the AR-based gaming application, each AR marker identifying a corresponding geolocation and corresponding AR content;
forming a gaming geographic area based on a profile of a user of the AR-based gaming application;
mapping, by the one or more hardware processors, the geolocations of the plurality of AR markers to the gaming geographic area; and
dynamically scaling a playspace of the user of the AR-based gaming application to the gaming geographic area.

A second example provides a device according to the first example, wherein the operations further comprise:
forming a first geographic area;
forming a second geographic area around the first geographic area, both the first and second geographic areas being within the gaming geographic area;
mapping a first set of AR markers to a first level of the AR-based gaming application in the first geographic area;
mapping a second set of AR markers to a second level of the AR-based gaming application in the second geographic area, the plurality of AR markers including the first and second sets of AR markers;
forming a first-level playspace of the user inside the first geographic area; and
forming a second-level playspace of the user inside the second geographic area, the second level of the AR-based gaming application having a higher gaming difficulty than does the first level of the AR-based gaming application.

A third example provides a server according to any of the above examples, wherein the operations further comprise:
identifying a home geographic location from the profile of the user,
wherein the gaming geographic area is formed around the home geographic location.

A fourth example provides a server according to any of the above examples, wherein the operations further comprise:

identifying a home geographic location from the profile of the user;
forming a first geographic area around the home geographic location;
forming a second geographic area around the first geographic area;
mapping a first set of AR markers to a first level of the AR-based gaming application in the first geographic area;

mapping a second set of AR markers to a second level of the AR-based gaming application in the second geographic area, the plurality of AR markers including the first and second sets of AR markers;

forming a first-level playspace of the user inside the first geographic area; and
forming a second-level playspace of the user inside the second geographic area.

A fifth example provides a server according to any of the above examples, wherein the operations further comprise:
identifying user frequent geographic locations from the profile of the user,
wherein the gaming geographic area is formed around and includes the user frequent geographic locations.

A sixth example provides a server according to any of the above examples, wherein the operation further comprise:
identifying a first geographic location of the user from the profile of the user; and
identifying a second geographic location of the user from the profile of the user,
wherein the gaming geographic area is formed around and includes the first and second geographic locations, and
wherein the plurality of AR markers is mapped to the gaming geographic area between the first and second geographic locations of the user.

A seventh example provides a server according to any of the above examples, wherein the plurality of AR markers is identified in all game levels of the AR-based gaming application, and wherein all game levels of the AR-based gaming application are played in the playspace of the user of the AR-based gaming application.

An eighth example provides a server according to any of the above examples, wherein the operations further comprise:
receiving a geolocation of an AR device of the user;
retrieving an AR marker of the plurality of AR markers corresponding to the geolocation of the AR device; and
providing the AR content corresponding to the retrieved AR marker to the AR device,
wherein the AR device is configured to display the AR content at the geolocation of the AR device.

A ninth example provides a server according to any of the above examples, wherein the AR device is configured to receive sensor data from sensors in the AR device, the AR device configured to display the AR content in response to the sensor data being with predefined parameters.

A tenth example provides a server according to any of the above examples, wherein forming the gaming geographic area further comprises:
forming a first geographic area based on a home location of the user;
forming a second geographic area based on activities of the user on a social network application;
mapping a first set of AR markers of the plurality of AR markers to a first level of the AR-based gaming application in the first geographic area;
mapping a second set of AR markers of the plurality of AR markers to a second level of the AR-based gaming application in the second geographic area;
forming a first-level playspace of the user inside the first geographic area; and
forming a second-level playspace of the user inside the second geographic area.

What is claimed is:

1. A server comprising:
one or more hardware processors comprising an augmented reality (AR)-based gaming application, the AR-based gaming application configured to perform operations comprising:
identifying, by the one or more hardware processors, a plurality of AR markers from the AR-based gaming application, each AR marker identifying a corresponding geolocation and corresponding AR content;
forming a gaming geographic area based on a profile of a user of the AR-based gaming application;
mapping, by the one or more hardware processors, the geolocations of the plurality of AR markers to the gaming geographic area; and
dynamically scaling a playspace of the user of the AR-based gaming application to the gaming geographic area.

2. The server of claim 1, wherein the operations further comprise:
forming a first geographic area;
forming a second geographic area around the first geographic area, both the first and second geographic areas being within the gaming geographic area;
mapping a first set of AR markers to a first level of the AR-based gaming application in the first geographic area;
mapping a second set of AR markers to a second level of the AR-based gaming application in the second geographic area, the plurality of AR markers including the first and second sets of AR markers;
forming a first-level playspace of the user inside the first geographic area; and
forming a second-level playspace of the user inside the second geographic area, the second level of the AR-based gaming application having a higher gaming difficulty than does the first level of the AR-based gaming application.

3. The server of claim 1, wherein the operations further comprise:
identifying a home geographic location from the profile of the user,
wherein the gaming geographic area is formed around the home geographic location.

4. The server of claim 1, wherein the operations further comprise:
identifying a home geographic location from the profile of the user;
forming a first geographic area around the home geographic location;
forming a second geographic area around the first geographic area;
mapping a first set of AR markers to a first level of the AR-based gaming application in the first geographic area;
mapping a second set of AR markers to a second level of the AR-based gaming application in the second geographic area, the plurality of AR markers including the first and second sets of AR markers;
forming a first-level playspace of the user inside the first geographic area; and
forming a second-level playspace of the user inside the second geographic area.

5. The server of claim 1, wherein the operations further comprise:
identifying user frequent geographic locations from the profile of the user,
wherein the gaming geographic area is formed around and includes the user frequent geographic locations.

6. The server of claim 1, wherein the operation further comprise:
identifying a first geographic location of the user from the profile of the user; and
identifying a second geographic location of the user from the profile of the user,
wherein the gaming geographic area is formed around and includes the first and second geographic locations, and
wherein the plurality of AR markers is mapped to the gaming geographic area between the first and second geographic locations of the user.

7. The server of claim 1,
wherein the plurality of AR markers is identified in all game levels of the AR-based gaming application, and
wherein all game levels of the AR-based gaming application are played in the playspace of the user of the AR-based gaming application.

8. The server of claim 1, wherein the operations further comprise:
receiving a geolocation of an AR device of the user;
retrieving an AR marker of the plurality of AR markers corresponding to the geolocation of the AR device; and
providing the AR content corresponding to the retrieved AR marker to the AR device,
wherein the AR device is configured to display the AR content at the geolocation of the AR device.

9. The server of claim 8, wherein the AR device is configured to receive sensor data from sensors in the AR device, the AR device configured to display the AR content in response to the sensor data being with predefined parameters.

10. The server of claim 1, wherein forming the gaming geographic area further comprises:
forming a first geographic area based on a home location of the user;
forming a second geographic area based on activities of the user on a social network application;
mapping a first set of AR markers of the plurality of AR markers to a first level of the AR-based gaming application in the first geographic area;
mapping a second set of AR markers of the plurality of AR markers to a second level of the AR-based gaming application in the second geographic area;
forming a first-level playspace of the user inside the first geographic area; and
forming a second-level playspace of the user inside the second geographic area.

11. A method comprising:
identifying, using one or more hardware processors, a plurality of AR markers from an AR-based gaming application configured to be executed on a hardware processor of a server, each AR marker identifying a corresponding geolocation and corresponding AR content;
forming a gaming geographic area based on a profile of a user of the AR-based gaming application;
mapping, using the one or more hardware processors, the geolocations of the plurality of AR markers to the gaming geographic area; and
dynamically, using the one or more hardware processors, scaling a playspace of the user of the AR-based gaming application to the gaming geographic area.

12. The method of claim 11, further comprising:
forming a first geographic area;
forming a second geographic area around the first geographic area, both the first and second geographic areas being within the gaming geographic area;
mapping a first set of AR markers to a first level of the AR-based gaming application in the first geographic area;
mapping a second set of AR markers to a second level of the AR-based gaming application in the second geographic area, the plurality of AR markers including the first and second sets of AR markers;
forming a first-level playspace of the user inside the first geographic area; and
forming a second-level playspace of the user inside the second geographic area, the second level of the AR-based gaming application having a higher gaming difficulty than does the first level of the AR-based gaming application.

13. The method of claim 11, further comprising:
identifying a home geographic location from the profile of the user,
wherein the gaming geographic area is formed around the home geographic location.

14. The method of claim 11, further comprising:
identifying a home geographic location from the profile of the user;
forming a first geographic area around the home geographic location;
forming a second geographic area around the first geographic area;
mapping a first set of AR markers to a first level of the AR-based gaming application in the first geographic area;
mapping a second set of AR markers to a second level of the AR-based gaming application in the second geographic area, the plurality of AR markers including the first and second sets of AR markers;
forming a first-level playspace of the user inside the first geographic area; and
forming a second-level playspace of the user inside the second geographic area.

15. The method of claim 11, further comprising:
identifying user frequent geographic locations from the profile of the user,
wherein the gaming geographic area is formed around and includes the user frequent geographic locations.

16. The method of claim 11, further comprising:
identifying a first geographic location of the user from the profile of the user; and
identifying a second geographic location of the user from the profile of the user,
wherein the gaming geographic area is formed around and includes the first and second geographic locations, and
wherein the plurality of AR markers is mapped to the gaming geographic area between the first and second geographic locations of the user.

17. The method of claim 11,
wherein the plurality of AR markers is identified in all game levels of the AR-based gaming application, and
wherein all game levels of the AR-based gaming application are played in the playspace of the user of the AR-based gaming application.

18. The method of claim 11, further comprising:
receiving a geolocation of an AR device of the user;
retrieving an AR marker of the plurality of AR markers corresponding to the geolocation of the AR device; and
providing the AR content corresponding to the retrieved AR marker to the AR device,
wherein the AR device is configured to display the AR content at the geolocation of the AR device.

19. The method of claim 11, further comprising:
forming a first geographic area based on a home location of the user;
forming a second geographic area based on activities of the user on a social network application;
mapping a first set of AR markers of the plurality of AR markers to a first level of the AR-based gaming application in the first geographic area;
mapping a second set of AR markers of the plurality of AR markers to a second level of the AR-based gaming application in the second geographic area;
forming a first-level playspace of the user inside the first geographic area; and
forming a second-level playspace of the user inside the second geographic area.

20. A non-transitory computer-readable medium comprising instructions that, when executed by one or more processors of a computer, cause the computer to perform operations comprising:
identifying a plurality of AR markers from an AR-based gaming application configured to be executed on a hardware processor of a server, each AR marker identifying a corresponding geolocation and corresponding AR content;
forming a gaming geographic area based on a profile of a user of the AR-based gaming application;
mapping the geolocations of the plurality of AR markers to the gaming geographic area; and
dynamically scaling a playspace of the user of the AR-based gaming application to the gaming geographic area.
